(19) United States
(12) Patent Application Publication
(10) Pub. No.: US 2019/0048455 A1
(43) Pub. Date: Feb. 14, 2019

(54) CONTAINER APPLIED WITH FLUORIDE-FREE SURFACE COATING AND PREPARATION METHOD THEREOF

(71) Applicants: MING-TE CHIEN, Pingtung County (TW); WISLEY HUANG, Tainan City (TW)

(72) Inventors: MING-TE CHIEN, Pingtung County (TW); WESLEY HUANG, Tainan City (TW); CHIA-YI CHIEN, Pingtung County (TW); TZU-HSUAN CHIEN, Pingtung County (TW)

(21) Appl. No.: 15/800,641

(22) Filed: Nov. 1, 2017

(30) Foreign Application Priority Data
Aug. 11, 2017 (TW) 106127322

(51) Int. Cl. C23C 4/10; C09D 1/00; C23C 4/12; C23C 4/02; B65D 25/14; B23K 26/342

(52) U.S. Cl. CPC C23C 4/10; C09D 1/00; B23K 26/342; C23C 4/02; B65D 25/14; C23C 4/12

(57) ABSTRACT

A container applied with a fluoride-free surface coating and a preparation method thereof are provided. The preparation method comprises the steps of: providing a container structure substrate and a cladding material, wherein the cladding material is a boron nitride powder material having a chemical composition comprising 43 wt % of boron, 0.1 wt % of boron oxide, 0.03 wt % of carbon, and 0.15 wt % of water, and having a purity of 99.5%, a finess of 30 μm, and a density of 0.4 g/cm³; and then cladding the boron nitride powder material onto an inner surface of a body by using a cladding technology, to form a cladded layer. The container applied with a fluoride-free surface coating has a structure comprising: a body having an inner surface; and a cladded layer, formed on the inner surface by processing the boron nitride powder material by a cladding technology.

### CROSS-REFERENCE TO RELATED APPLICATION

This application claims the benefit of Taiwan Patent Application No. 106127322, filed on Aug. 11, 2017, which is hereby incorporated by reference for all purposes as if fully set forth herein.

### BACKGROUND

### Technical Field

The present invention relates to a container and a preparation method thereof, and particularly to a container applied with a fluoride-free surface coating and a preparation method thereof.

### Related Art

The reason underlying the non-stickiness of a non-sticky container such as non-sticky pan is that a “Teflon” coating is present in the container (for example, at the bottom of the pan). Teflon materials are fluorine-containing resins including polytetrafluoroethylene, polyperfluoroethylene-propylene and various fluorine-containing copolymers. By applying a coating of polytetrafluoroethylene that is commonly known as “Teflon”, the non-sticky pan is allowed to have a high- and low-temperature resistance (−190-260° C.), a corrosion resistance (resistance to acids and bases), and other properties. However, it is pointed out by the Journal of Food and Drug Analysis that perfluorooctanoic acid (PFOA) in the Teflon coating of a non-sticky pan has potential to be dissolved out in the presence of high temperature, hot oil, and acid flavourings. According to a study published in Am J Gastroenterol in 2010, the increase in PFOA concentration in the blood may cause increased liver inflammation index and easily cause abnormal metabolism of adipose tissue. PFOA may cause liver damage and have impact on the endocrine system, and has been classified by the International Agency for Research on Cancer (IARC) as a potential Category 2A carcinogen.

The raw material of the coating of a non-sticky pan is mainly polytetrafluoroethylene-containing Teflon. From the perspective of an existing coating forming technology for Teflon non-sticky pans, the Teflon non-sticky pans have the following defects. 1) The usage temperature is restricted to 250° C. or below because the Teflon coating is decomposed at a high temperature and gases harmful to human are released; and the bonding strength of polytetrafluoroethylene is less high, and the coating is caused to be peeled off when the surface of a non-sticky kitchenware is scratched with a metal tool. 2) The non-sticky pan cannot be used to cook acid food, because the metal body can be easily corroded by an acidic substance; and care should be taken to avoid the problem of abrasion during washing the non-sticky kitchenware. If the coating forming technology for Teflon non-sticky pan is employed, the above problems always exist.

However, the pan bodies of the non-sticky pans available in the market are mainly made with aluminum alloys having a thick layer of alumina on the surface; stainless steel having a layer of chromium oxide on the surface and having a high corrosion resistance and a slow corrosion rate; and also iron that is easy to be largely corroded by an acid to raise the coating.

### SUMMARY

An object of the present invention is to provide a container applied with a fluoride-free surface coating and a preparation method thereof by using a cladding technology, in which container substrates of various materials can be metallurgically bonded to a cladding material.

For achieving the object of providing a container, the following technical means is adopted in the present invention. The present invention provides a container applied with a fluoride-free surface coating, which has a structure comprising: a body, having an inner surface for holding food materials; and a cladded layer, formed on the inner surface by processing a food-grade boron nitride powder material having a chemical composition comprising 43 wt % of boron (B), 0.1 wt % of boron oxide (B₂O₃), 0.03 wt % of carbon, and 0.15 wt % of water (H₂O), and having a purity of 99.5%, a finess of 30 μm, and a density of 0.4 g/cm³ by a cladding technology.

In an embodiment, the body is made with a metal or a ceramic material.

For achieving the object of providing a method for preparing the coating, the following technical means is adopted in the present invention. The present invention provides a method for preparing a fluoride-free surface coating of a container, which comprises the steps of providing a container structure substrate and a cladding material, where the cladding material is a boron nitride powder material having a chemical composition comprising 43 wt % of boron (B), 0.1 wt % of boron oxide (B₂O₃), 0.03 wt % of carbon, and 0.15 wt % of water (H₂O), and having a purity of 99.5%, a finess of 30 μm, and a density of 0.4 g/cm³; and then cladding the boron nitride powder material onto an inner surface of a body of the container structure substrate by using a cladding technology, to form a cladded layer.

In an embodiment, the processing by a cladding technology is selected from the group consisting of hot spraying, chemical plating, physical plating, and laser cladding, and a cladded layer of composite ceramic structure is formed on the inner surface with implanted pore structures of the body by cladding.

In an embodiment, the container structure substrate is made with a metal or a ceramic material, and the to-be-cladded inner surface has a processing precision of not less than IT7.

In an embodiment, the cladding technology is laser cladding, in which the powder feeding mode is synchronous powder feeding or fore-put powder feeding, the powder feeding gas is an inert gas, and the parameters for the laser cladding technology comprise: laser power 1000-3500 W, sweep speed 3-12 mm/S, and powder feeding rate 6-20 g/min. The laser cladding technology is selected from the group consisting of single-track forming, multi-track overlapping, multi-layer track stacking and closed curved track docking.

In an embodiment, the cladding material is a hard alloy ceramic material, or a powdered hard alloy ceramic material having an average particle size of 60 to 160 μm.

In an embodiment, before the cladding step, the inner surface of the body is processed by sandblasting, rolling, or embossing, to form well-distributed implanted pore structures.

The present invention has the following features. With respect to the selection of the cladding material in the present invention, the boron nitride material has the advantages of improving the defects of the conventional “Teflon” coating, such as toxicity, poor corrosion resistance, poor physical/chemical stability, and poor abrasive resistance. In the present invention, synchronous powder feeding or fore-put powder feeding is employed, and parameters corresponding to the nature of the cladding technology and optimizing the cladding technology are selected. During the implementation of the technology, four technical approaches including overlapping, stacking and others are involved, and metallurgical bonding between the cladding material and the substrate is realized through the laser cladding technology. By means of the present invention, the surface property of a metal or ceramic container can be effectively strengthened, whereby the container is maintained, on a long-term basis, to have an intact surface layer that is chemically stable, non-toxic and safe. In the present invention, the technology for preparing the non-sticking container is simple, the preparation process is safe and environmentally friendly, and the prepared container has the features of containing no fluoride, causing no injury to human health, good wear resistance and long service life, thus well solving the defects existing for the Teflon non-sticky coating, such as toxicity, poor corrosion resistance, poor physical/chemical stability, and poor abrasive resistance; and also solving the problem that the non-sticky pan cannot be used at a temperature exceeding 250 degrees Celsius, and cannot be used for cooking and holding acid food, and others. In the present invention, the advantages of the cladding technology are made full use, and a container applied with a fluoride-free surface coating and a method for preparing the fluoride-free surface coating are achieved. 1. Different materials (metal or ceramic container substrates) are metallurgically bonded to the cladding material, and the dilution rate is small, such that the cladding material is maintained to have a high-temperature resistance, a corrosion resistance, a physical/chemical stability, a good thermal conductivity, an extraordinarily high hardness, a wear resistance, a good self-lubricating performance, and a good chemical stability, which is thus approved by US FDA for use as an additive in the food industry, and by which a non-sticky characteristic is imparted and the surface properties of a metal or ceramic container can be effectively strengthened. 2. In the present invention, the cladded layer is shaped by a near-net forming technology, thereby reducing the post-precision machining. 3. By means of the technique of the present invention, the surface layer on the inner surface of the container is maintained to be physically/chemically sate, non-toxic and safe, and contain no fluoride on a long-term basis.

### BRIEF DESCRIPTION OF THE DRAWINGS

FIG. 1 is a schematic cross-sectional diagram showing the structure of a container with a fluoride-free surface coating according to the present invention;

FIG. 2 is a flow chart of a method for preparing a fluoride-free surface coating of a container according to the present invention;

FIG. 3 is a schematic diagram showing a cladding technology of the present invention that is laser cladding with coaxial powder feeding; and

FIG. 4 is a schematic diagram showing a cladding technology of the present invention that is laser cladding with lateral powder feeding.

### DETAILED DESCRIPTION

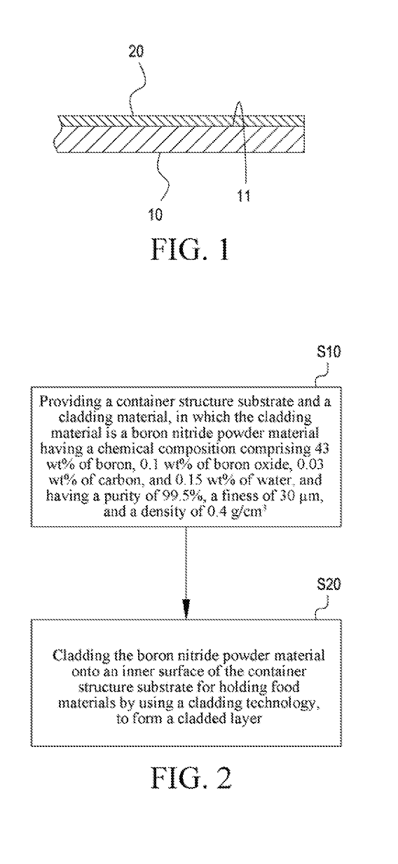

Referring to FIG. 1, a container applied with a fluoride-free surface coating provided in this embodiment has a structure comprising a body 10 having an inner surface 11 for holding food materials, in which the body 10 may be made with a metal or a ceramic material; and a cladded layer 30 formed on the inner surface 11 by processing a boron nitride powder material having a chemical composition comprising 43 wt % of boron (B), 0.1 wt % of boron oxide (B₂O₃), 0.03 wt % of carbon, and 0.15 wt % of water (H₂O), and having a purity of 99.5%, a finess of 30 μm, and a density of 0.4 g/cm³ by a cladding technology.

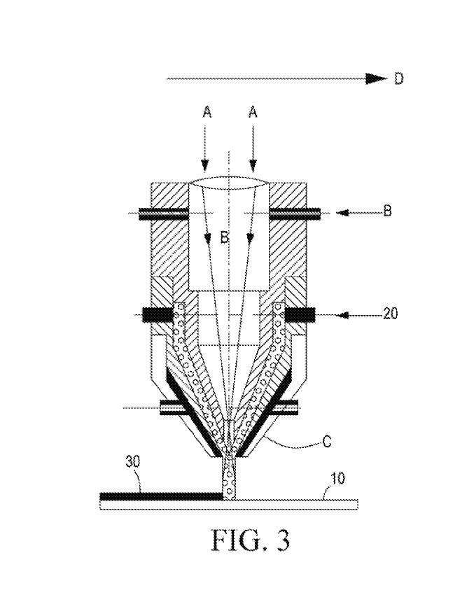

Referring to FIGS. 2 to 4, a method for preparing a fluoride-free surface coating of a container provided in this embodiment comprises:

Step S10: providing a body 10 of a container structure substrate and a cladding material, in which the cladding material is a boron nitride powder material 20 having a chemical composition comprising 43 wt % of boron (B), 0.1 wt % of boron oxide (B₂O₃), 0.03 wt % of carbon, and 0.15 wt % of water (H₂O), and having a purity of 99.5%, a finess of 30 μm, and a density of 0.4 g/cm³; and

Step S20: cladding the boron nitride powder material 20 onto an inner surface 11 of the body 10 of the container structure substrate by using a cladding technology, to form a cladded layer 30.

A method for preparing a fluoride-free surface coating of a container comprises: Step S10: providing a body 10 of a container structure substrate and a cladding material, in which the cladding material is a boron nitride powder material 20 having a chemical composition comprising 43 wt % of boron (B), 0.1 wt % of boron oxide (B₂O₃), 0.03 wt % of carbon, and 0.15 wt % of water (H₂O), and having a purity of 99.5%, a finess of 30 μm, and a density of 0.4 g/cm³; and Step S20: cladding the boron nitride powder material 20 onto an inner surface 11 of the body 10 of the container structure substrate by using a cladding technology, to form a cladded layer 30.

In an embodiment, the processing by a cladding technology is selected from the group consisting of hot spraying, chemical plating, physical plating, and laser cladding, and a cladded layer of composite ceramic structure is formed on the inner surface with implanted pore structures of the body by cladding.

In an embodiment, the body of the container structure substrate is made with a metal or a ceramic material, and the to-be-cladded surface has a processing precision of not less than IT7.

In an embodiment, the cladding technology is laser cladding, in which the powder feeding mode is synchronous powder feeding or fore-put powder feeding (where in the synchronous powder feeding mode, the powder is directly fed to a moving melt pool formed by laser radiation, and the coating is formed at a time; and in the fore-put powder feeding mode, the powder is laid previously in a region through which a traveling path of a laser head runs, and then irradiated by a laser beam), the powder feeding gas is an inert gas, and the parameters for the laser cladding technology comprise: laser power 1000-3500 W, sweep speed 3-12 mm/S, and powder feeding rate 6-20 g/min. The laser cladding technology is selected from the group consisting of single-track forming, multi-track overlapping, multi-layer track stacking and closed curved track docking.

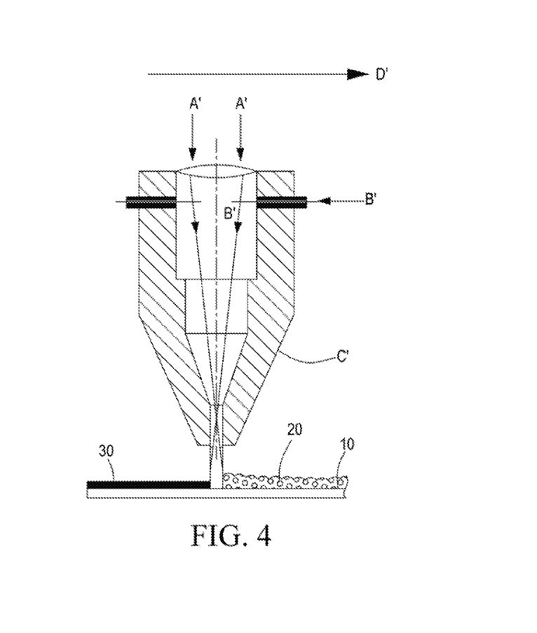

FIG. 3 is a schematic diagram showing a cladding technology used in the above embodiment that is laser cladding with coaxial powder feeding, where the coaxial powder feeding is a synchronous powder feeding mode. In FIG. 3, a laser head C moves towards a travelling direction D, and a laser beam A travels through the laser head C filled with a protective gas B and the boron nitride powder material 20, and is then irradiated onto a surface of the body 10 after passing through the laser head C, whereby the boron nitride powder material 20 is cladded onto the surface of the body 10, to form a cladded layer 30. FIG. 4 is a schematic diagram showing a cladding technology of the present invention that is laser cladding with fore-put powder feeding. In FIG. 4, a laser head C′ moves towards a travelling direction D′, the boron nitride powder material 20 is laid previously in a processing region on the surface of the body 10 irradiated by a laser beam A′, and then the laser beam A′ travels through the laser head C′ filled with a protective gas B′, and is irradiated onto the processing region on the surface of the body 10, such that the boron nitride powder material 20 is cladded to form a cladded layer 30.

In an embodiment, the cladding material is a hard alloy ceramic material or a powdered hard alloy ceramic material having an average particle size of 60-160 μm.

In an embodiment, wherein before the cladding step, the inner surface of the body is processed by sandblasting, rolling, or embossing, to form well-distributed implanted pore structures.

What is claimed is:

1. A container applied with a fluoride-free surface coating, having a structure comprising:
a body, having an inner surface for holding food materials; and
a cladded layer, formed on the inner surface by processing a boron nitride powder material having a chemical composition comprising 43 wt % of boron (B), 0.1 wt % of boron oxide (B₂O₃), 0.03 wt % of carbon, and 0.15 wt % of water (H₂O), and having a purity of 99.5%, a finess of 30 μm, and a density of 0.4 g/cm³ by a cladding technology.

2. The container applied with a fluoride-free surface coating according to claim 1, wherein the body is made with a metal or a ceramic material.

3. A method for preparing a fluoride-free surface coating of a container, comprising the steps of:
providing a body of a container structure substrate and a cladding material, wherein the cladding material is a boron nitride powder material having a chemical composition comprising 43 wt % of boron (B), 0.1 wt % of boron oxide (B₂O₃), 0.03 wt % of carbon, and 0.15 wt % of water (H₂O), and having a purity of 99.5%, a finess of 30 μm, and a density of 0.4 g/cm³; and
cladding the boron nitride powder material onto an inner surface of the body for holding food materials by using a cladding technology, to form a cladded layer.

4. The method for preparing a fluoride-free surface coating according to claim 3, wherein the processing by a cladding technology is selected from the group consisting of hot spraying, chemical plating, physical plating, and laser cladding, and a cladded layer of composite ceramic structure is formed on the inner surface with implanted pore structures of the body by cladding.

5. The method for preparing a fluoride-free surface coating according to claim 3, wherein the body of the container structure substrate is made with a metal or a ceramic material, and the to-be-cladded inner surface for holding food materials has a processing precision of not less than IT7.

6. The method for preparing a fluoride-free surface coating according to claim 3, wherein the cladding technology is laser cladding, in which the powder feeding mode is synchronous powder feeding or fore-put powder feeding, the powder feeding gas is an inert gas, and the parameters for the laser cladding technology comprise: laser power 1000-3500 W, sweep speed 3-12 mm/S, and powder feeding rate 6-20 g/min.

7. The method for preparing a fluoride-free surface coating according to claim 3, wherein the cladding material is a hard alloy ceramic material, or a powdered hard alloy ceramic material having an average particle size of 60 to 160 μm.

8. The method for preparing a fluoride-free surface coating according to claim 3, wherein before the cladding step, the inner surface of the body is processed by sandblasting, rolling, or embossing, to form well-distributed implanted pore structures.

9. The method for preparing a fluoride-free surface coating according to claim 6, wherein the laser cladding technology is selected from the group consisting of single-track forming, multi-track overlapping, multi-layer track stacking and closed curved track docking.

10. The method for preparing a fluoride-free surface coating according to claim 3, wherein the body of the container structure substrate is joined to the cladding material by metallurgical bonding.
